(19) United States
(12) Patent Application Publication
(10) Pub. No.: US 2006/0236836 A1
(43) Pub. Date: Oct. 26, 2006

(54) Dispensing device for paper sheets obtained by manual cutting from a continuous band with triggering mechanism for a spare roll

(76) Inventor: Antonio Macchi Cassia, Milano (IT)

Correspondence Address: LUCAS & MERCANTI, LLP, 475 PARK AVENUE SOUTH, 15TH FLOOR, NEW YORK, NY, 10016, US

(21) Appl. No.: 10/563,007

(22) PCT Filed: Jul. 1, 2004
(86) PCT No.: PCT/IT04/00385

§ 371 Date: Apr. 20, 2006

(30) Foreign Application Priority Data
Jul. 17, 2003 (IT) MI 2003 A 001465

(51) Int. Cl. B26F 3/00; B26D 7/00

(52) U.S. Cl. 83/649; 225/1; 225/14; 225/20

(57) ABSTRACT

A dispensing device for paper sheets cut from a continuous band wound up in a roll (R) comprises a case consisting of a base (1) and a cover (3) provided with a bottom opening (4) as paper outlet, a mechanism for automatically replacing the finished roll (R) with a spare roll (R′), a band feeding and cutting unit of the type in which it is the pull exerted by the user on the tip of paper (C) projecting from the device that controls the feeding of a pre-established length of band and the cutting thereof, means (19) for retaining the starting tip (S) of the spare roll (R′), means (2) for the top hinging of the cover (3) to the base (1) and connection means suitable to turn a push on the cover (3) into a driving impulse for the feeding and cutting unit, the cover (3) being provided with an inclined plane (15) internally projecting downward at the area of nipping of the paper (C) by the feeding and cutting unit. Thanks to this structure, the user can cause the driving of the feeding and cutting unit by pushing on the cover (3) and thus make the tip (C) come out when it is not automatically dispensed by the device.

The present invention relates to devices for the controlled dispensing of portions of paper from a continuous band to be used as toilet paper or towels, and in particular to a device of the manually-operated type and provided with a mechanism for initiating a spare roll. Specific reference will be made hereafter to a toilet paper device, while it is clear that what is said can be applied with obvious modifications to paper towels, kitchen rolls and the like.

There are known devices for dispensing sheets of paper from a continuous band in which it is the pull exerted by the user on the tip of paper projecting from the device that controls the feeding of a pre-established length of band and the cutting thereof. This type of device is preferable over the simpler type in which the cutting blade is fixed and the user must carry thereon the portion of paper to severe it from the band, since in this case it is left up to the user the choice of the length of the portion of band to be cut with consequential unavoidable wastes. Moreover, such a device implies the presence of a blade in an accessible and therefore potentially dangerous position.

These manually-operated devices include a cutting unit that can be made in different ways, for example with a blade that springs out radially from a rest position within the paper band feed roller, or with a blade that acts on the strip of paper in a radial direction from outside towards the inside of the feed roller by entering a longitudinal slot thereof.

However the preferred solution, to which reference will be made hereafter, is that where a first blade is mounted on the feed roller and a second blade is fixedly mounted and positioned to interfere with said first blade carried by the roller, said pair of blades being mounted and structured so as to achieve during the cutting a punctiform contact between a rigid blade and a yielding blade. Examples of this type of cutting mechanism are disclosed in patents EP 693268 and EP 930039, while it is clear that any kind of cutting unit among those mentioned above can be used in the present device.

Regardless of the type of cutting unit being used, there is provided a side knob so that the operator can manually rotate the roller when loading the device with a new roll. Unfortunately said operation must be repeated quite frequently for the devices placed in intensive use locations, typically public spaces, stations, etc. Moreover there is problem of checking the device with the same frequency to make sure that the roll is not finished.

In order to overcome this drawback the applicant has been producing since some time a dispenser that includes a mechanism for automatically replacing the finished roll with a second spare roll also housed within the device. However this dispenser has the drawback that it can be used only with rolls of pre-cut paper, or it must be provided with a fixed blade for the cutting by the user as previously mentioned. This is due to the necessity of making the spare roll immediately available and operative, without requiring the intervention of the operator to initiate the latter through an automatic cutting unit of the type mentioned above.

Therefore the object of the present invention is to provide a device for dispensing paper sheets which overcomes the above-mentioned drawbacks.

This object is achieved by means of a device that combines a cutting unit, a roll replacement mechanism and means for initiating the spare roll.

The main advantage of the present device is that of combining the advantages of the above-mentioned two types of dispensers, so as to prevent waste of paper while extending the intervals between the operator interventions to check and re-load the device.

A second advantage of this device is given by the fact that the initiating means are useful not only at the time of the roll replacement, but they can also be used to make the paper tip project out of the device if for any reasons it occurs that the tip is not automatically dispensed.

A further advantage of said device is that this result is achieved through a very simple, cheap and reliable mechanism.

These and other advantages and characteristics of the device according to the present invention will be clear to those skilled in the art from the following detailed description of an embodiment thereof, with reference to the annexed drawings wherein:

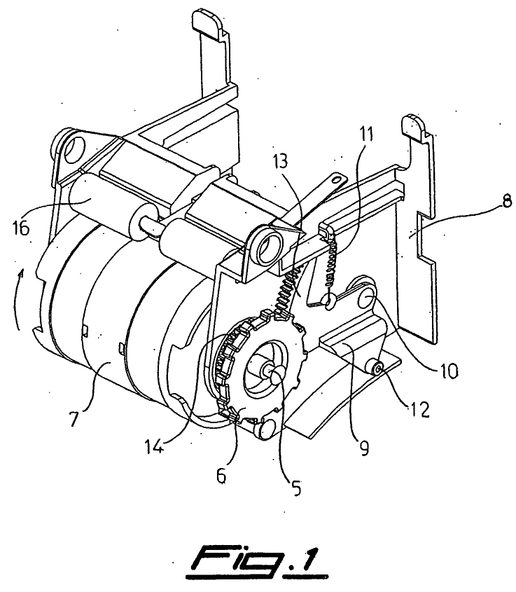

FIG. 1 is a perspective top view of the cutting unit of the present device;

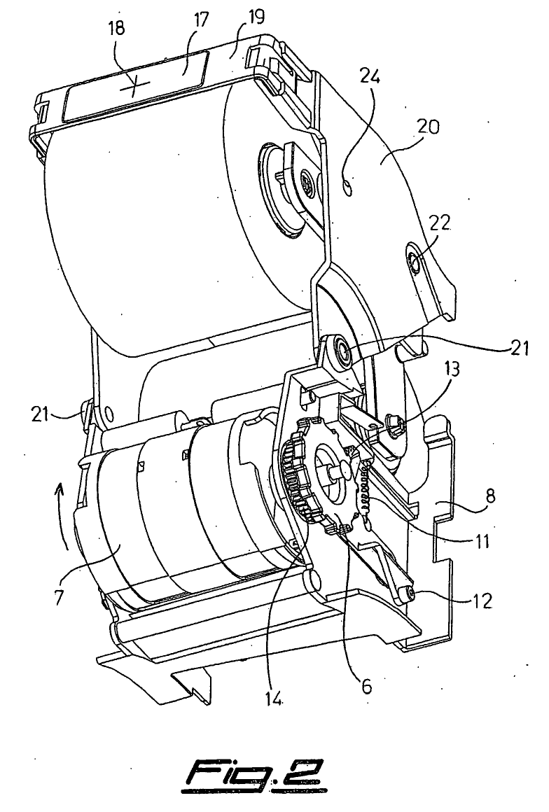

FIG. 2 is a perspective bottom view of said cutting unit combined with the roll replacement mechanism;

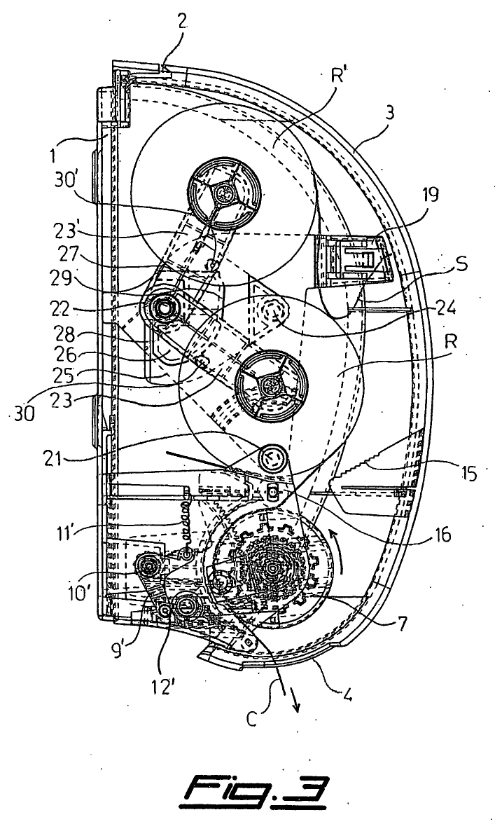

FIG. 3 is a vertical sectional view from the left side of the device at the beginning of the use with two complete rolls;

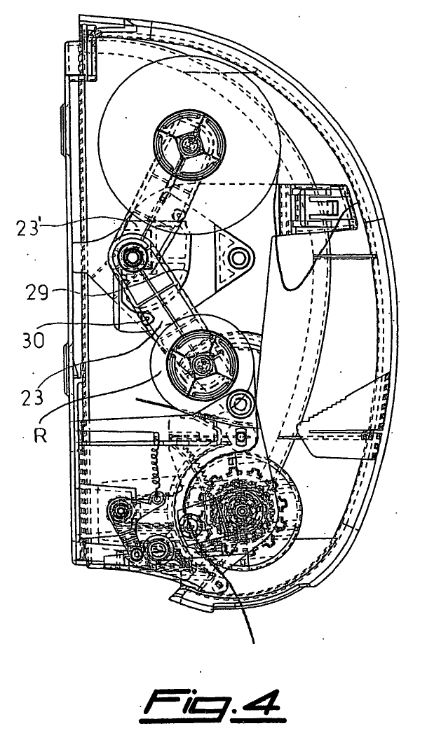

FIG. 4 is a view similar to the preceding one with the first roll used for about ⅔;

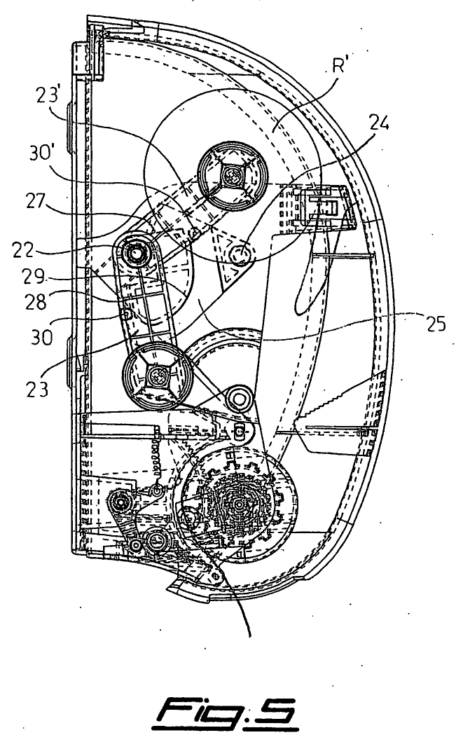

FIG. 5 is a view similar to the preceding one with the first roll almost finished at the moment of the triggering of the replacement mechanism; and

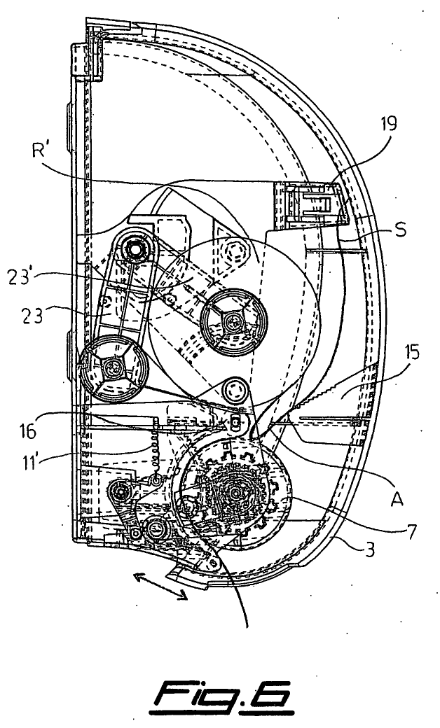

FIG. 6 is a view similar to the preceding one with the spare roll positioned for initiation.

Referring to FIGS. 1 to 3, there is seen that the case of the device is made up of a rear base 1 to which, through top teeth 2, there is hinged a cover 3 provided with a bottom opening 4 as paper outlet, the teeth 2 acting also as a lock that can be disengaged only by means of a suitable tool. The cover 3 is also connected at the bottom to the device body, in order to limit its rotation and to prevent its lifting, through a flexible strap (not shown) secured between the inside of the cover and the right end of the main shaft 5 of the cutting unit. On said shaft 5 there is also mounted a knob 6 for the initial feeding of the band when the device is loaded with a new roll, so as to be able to rotate manually the feeding and cutting roller 7 mounted on said shaft 5.

Further details about the structure and operation of the feeding and cutting unit illustrated in FIG. 1 can be found in the above-mentioned patent EP 930039 that illustrates a similar unit twice the size, and provided with two pairs of blades, but having substantially the same structure. In the present description there are underlined only the additional members that have been added to the device to provide the novel function of initiating the spare roll.

More specifically, on the sides of the frame 8 of the cutting unit there are pivoted a pair of rocker-arms 9, 9′, substantially shaped as an inverted L, rotatable around pivots 10, 10′ and kept raised by return springs 11, 11′. At the lower ends of the rocker arms there are provided pins 12, 12′ on which internal projections (not shown) of cover 3 are rotatably engaged, so that a push of the user on the outside of cover 3, that rotates around teeth 2, is turned into a downward rotation of the horizontal portions of the rocker arms.

The right rocker arm 9 terminates on the front with a toothed sector 13 that engages a gear 14 also keyed on shaft 5, while the left rocker arm 9′ is only meant to achieve a balanced movement of cover 3 since it does not engage any other member. Moreover, shaft 5 is also provided with a non-return mechanism due to which roller 7 can only rotate upward (when seen from the front) whereas the driving in the opposite direction, as in the return travel of the toothed sector 13, is turned into a relative sliding of the engaged members.

In practice, thanks to the above-mentioned transmission mechanism, the user causes a rotation of roller 7 by pushing on cover 3 same as if the operator would act on knob 6 when the device is open. This allows to force the projection of the paper in case of clogging of the roll and it also favours the initiation of the spare roll at the time of replacing the first roll, in case it should be necessary. The present device furthermore includes other two members that cooperate with the above-mentioned mechanism to achieve said result.

The first member consists of an inclined notched plane 15 internally projecting downward from cover 3 at the upper portion of the cutting unit. More precisely, the plane is oriented so that its ideal extension arrives at the nipping line of paper C between roller 7 and an upper small counter-pressure roller 16.

The second member consists of a rubber panel 17 with a central cross-shaped cut 18, said panel 17 being secured to a transverse plate 19 that is in turn mounted on the frame 20 of the roll-holding unit. The starting tip S of the spare roll R′ is inserted into cut 18 for the reason explained further on, said roll R′ being placed in the device, as shown in FIG. 3, so that its downward movement does not cause the removal of tip S from panel 17.

Frame 20 is mounted on frame 8 through pivots 21, and on its inside there is a first pivot 22 that carries a pair of independent arms 23, 23′ carrying respectively the first roll R and the spare roll R′. On the same internal side of frame 20, a second more advanced pivot 24 carries a plate 25 on which there is formed a cam 26. This cam 26 is shaped with a horizontal top portion 27 and a rear vertical portion 28 connected by a substantially curved front portion 29. Moreover, each arm 23, 23′ is provided with a relevant peg 30, 30′ positioned so that it can follow the profile of cam 26.

The simple and effective operation of the present device, as will be now illustrated, can be easily understood from the description above with the help of FIGS. 4-6.

When the operator loads the device, the continuous paper band C unwound from roll R carried by arm 23 is introduced frontally between the counter-pressure roller 16 and roller 7, which is advanced by means of knob 6 until the band comes out through the opening 4. In this initial position peg 30′ is close to the forward end of the horizontal portion 27 and therefore supports arm 23′, cam 26 being supported in turn by peg 30 that is in the lower part of the curved portion 29 and prevents the rotation of plate 25 around pivot 24 since the position of arm 23 is defined by roll R resting on roller 16.

When the user pulls the projecting tip of band C, this causes the rotation of roller 7 and the subsequent cutting of a length of band. As shown in FIG. 4, as a result of the progressive decrease in diameter of roll R that is being used, arm 23 rotates downward and the relevant peg 30 gets closer to the bottom end of the curved portion 29, while arm 23′ remains in the initial raised position.

Through the continuous drawing of paper the moment, illustrated in FIG. 5, is finally reached when the roll replacement mechanism starts its operation: the first roll is almost finished and arm 23 has rotated downward so much that peg 30 has “turned” from portion 29 to the vertical portion 28. As a consequence, peg 30 no longer prevents the rotation of plate 25 around pivot 24 due to the weight of the spare roll R′, and a small rotation of the plate is sufficient for peg 30′ to “turn” from the horizontal portion 27 to the curved portion 29 thus causing the descent of arm 23′. The same peg 30′ then takes plate 25 back to the initial position thereof by following the profile of portion 29.

The position illustrated in FIG. 6 is thus reached, where arm 23′ has taken the operating position occupied by arm 23 in FIG. 3, the latter having moved completely to the back under the push of the roll carried by arm 23′. The starting tip S of roll R′, however, remains inserted in the transverse plate 19 during the descent of arm 23′, so that the band forms a loop A extending between roller 7 and the inclined plane 15.

In this condition when the user pulls the projecting tip of roll R, still engaged between rollers 7 and 16, thus rotating roller 7 he also draws loop A into engagement between said rollers. As a consequence, during some dispensing cycles the device will dispense a double sheet, until roll R is finished, whereafter it will continue with roll R′ only. In practice, once the first rotation of roller 7 is carried out, the starting tip S becomes disengaged from the transverse plate 19 and roll R′ can be normally used.

In case roll R′ is not automatically initiated in the above-described way, it is sufficient that the user pushes a few times on cover 3, which each time returns to the rest position thanks to springs 11, 11′ as previously explained, for loop A to be nipped between roller 7 and roller 16 also thanks to the push and support of the notched plane 15.

When also roll R′ is finished, in order to re-load the device the operator-disengages teeth 2 with a suitable tool and opens cover 3 by rotating it downward so that it remains supported by pins 12, 12′ and by the restraint strap. Then he rotates frame 20 forward to complete the rotation of arms 23, 23′ that are loaded with new rolls and re-positioned along cam 26, returns frame 20 to its rest position, secures tip S of the new roll R′, manually initiates the first roll R by means of knob 6 and re-engages cover 3 on teeth 2 so as to go back to the initial position of FIG. 3.

It is clear that the above-described and illustrated embodiment of the device according to the invention is just an example susceptible of various modifications. In particular, the means to retain tip S of roll R′ can be different from the illustrated means 17, 18 19, as well as the kinematical connection that turns the push on cover 3 into a rotation of roller 7. In other words, the various members such as rocker arm 11, toothed sector 13 and gear 14 can be replaced by other mechanically equivalent members, and the same applies to the roll replacement mechanism as long as the device operation is retained as illustrated above.

1. A dispensing device for paper sheets cut from a continuous band wound up in a roll (R), comprising a case consisting of a base (1) and a cover (3) provided with a bottom opening (4) as paper outlet, characterized in that it includes a mechanism for automatically replacing the finished roll (R) with a spare roll (R′), a band feeding and cutting unit of the type in which it is the pull exerted by the user on the tip of paper (C) projecting from the device that controls the feeding of a pre-established length of band and the cutting thereof, means for retaining the starting tip (S) of said spare roll (R′), means for the top hinging of said cover (3) to said base (1) and connection means suitable to turn a push on the cover (3) into a driving impulse for said feeding and cutting unit.

2. A device according to claim 1, characterized in that the mechanism for automatically replacing the roll (R) consists of a frame (20) rotatably mounted on a frame (8) of the feeding and cutting unit, said frame (20) being provided on its inside with a first pivot (22) that carries a pair of independent arms (23, 23′) carrying respectively the first roll (R) and the spare roll (R′), on the same internal side of the frame (20) there being provided a second more advanced pivot (24) that carries a plate (25) on which there is formed a cam (26) shaped with a horizontal top portion (27) and a rear vertical portion (28) connected by a substantially curved front portion (29), each of said arms (23, 23′) being provided with a relevant peg (30, 30′) positioned so that it can follow the profile of said cam (26).

3. A device according to claim 1 or 2, characterized in that the means for retaining the starting tip (S) of the spare roll (R′) consist of a rubber panel (17) with a cross-shaped cut (18).

4. A device according to claim 2 and 3, characterized in that the rubber panel (17) is secured to a transverse plate (19) that is in turn mounted on the frame (20) of the roll replacement mechanism.

5. A device according to one or more of the preceding claims, characterized in that the means for the top hinging of the cover (3) to the base (1) consist of teeth (2) formed at the top of the base (1) and suitable to rotatably engage the cover (3), the latter being also connected at the bottom to the device body through a flexible strap suitable to limit its rotation and to prevent its lifting.

6. A device according to one or more of the preceding claims, characterized in that the connection means suitable to turn a push on the cover (3) into a driving impulse for the feeding and cutting unit consist of a pair of rocker arms (9, 9′) pivoted to the sides of the frame (8) of the feeding and cutting unit, return springs (11, 11′) for said rocker arms (9, 9′), and pins (12, 12′) located at the ends of the rocker arms (9, 9′) on which internal projections of the cover (3) are rotatably engaged, at least one rocker arm (9) being provided with a toothed sector (13) that engages a gear (14) keyed on the main shaft of the feeding and cutting unit, the latter being provided with a non-return mechanism due to which a driving in the opposite direction is turned into a relative sliding of the engaged members.

7. A device according to one or more of the preceding claims, characterized in that the feeding and cutting unit is of the type where a first blade is mounted on the feed roller (7) and a second blade is fixedly mounted and positioned to interfere with said first blade carried by said roller (7), said pair of blades being mounted and structured so as to achieve during the cutting a punctiform contact between a rigid blade and a yielding blade.

8. A device according to one or more of the preceding claims, characterized in that the cover (3) is provided with an inclined plane (15) internally projecting downward at the area of nipping of the paper (C) by the feeding and cutting unit.

9. A device according to claim 8, characterized in that the inclined plane (15) is oriented so that its ideal extension arrives at the line of nipping of the paper (C) by the feeding and cutting unit.

10. A device according to claim 8 or 9, characterized in that the inclined plane (15) is notched.
